(19) United States
(12) Patent Application Publication
(10) Pub. No.: US 2011/0230198 A1
(43) Pub. Date: Sep. 22, 2011

(54) Apparatus and Method

(76) Inventors: Vinh Van Phan, Oulu (FI); Ling Yu, Oulu (FI); Markku Vainikka, Kiviniemi (FI); Kari Horneman, Oulu (FI); Klaus Pedersen, Aalborg (DK); Frank Frederiksen, Klarup (DK)

(21) Appl. No.: 13/132,639

(22) PCT Filed: Dec. 5, 2008
(86) PCT No.: PCT/EP2008/066886

§ 371 Date: Jun. 3, 2011

(51) Int. Cl. H04B 7/26; H04B 15/00; H04W 72/00

(52) U.S. Cl. 455/450; 455/509; 455/501

(57) ABSTRACT

An apparatus and a method are provided. The provided solution includes determining at least one sub cell specific spectrum load characteristic by an apparatus serving a sub cell; receiving neighbor cell information from an apparatus serving a cell and transmitting the at least one spectrum characteristic to the apparatus serving a cell.

### FIELD

The embodiments of the invention relate generally to communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Network planning of a cellular telecommunication network undergoes constant development due to increasing and/or changing capacity requirements and appearance of new structures affecting the coverage of cellular networks. Generally, network coverage has been achieved with cells served by base stations covering relatively large areas. These base stations may be called Wide Area (WA) base stations. Usually, base stations serving these cells have been installed by network operators. Operators may have performed extensive networks planning calculations to optimize spectrum usage and load of base stations.

Modern communications systems under development provide a possibility to install local area (LA) base stations in the network. These base stations may be installed within buildings to provide additional coverage and capacity in homes and offices. These base stations may utilize so called “plug-and-play” operation with self-organizing network (SON) and flexible spectrum use (FSU) techniques.

Main targets of these techniques are to minimize the need for network configuration and enable new types of communications networks, such as decentralized ad hoc networks. The techniques enable self-tuning and reconfiguration of network parameters of the LA base stations. In addition, the techniques provide some solutions for utilizing and sharing spectrum resources among communication systems of the same or different operators serving in overlapping or even common spectrum and/or geographical area.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to an aspect of the present invention, there is provided an apparatus comprising: a controller configured to determine at least one sub cell specific spectrum load characteristic; a receiver configured to serve the sub cell and receive neighbor cell information from the apparatus serving a cell; and a transmitter configured to serve the sub cell and transmit the at least one spectrum and characteristic to an apparatus serving a cell.

The spectrum load characteristic may comprise inter cell interference co-ordination related signaling information.

The apparatus may be configured to transmit the spectrum load characteristic periodically.

The apparatus may be configured to transmit the spectrum load characteristic on demand.

The apparatus may be configured to utilize a self-organizing network and flexible spectrum use techniques.

According to an aspect of the present invention, there is provided an apparatus comprising: a transceiver configured to serve a cell and configured to receive at least one sub cell specific spectrum load characteristic from an apparatus serving a sub cell; and a controller configured to generate collective neighbor cell information related to received sub cell specific spectrum load characteristics and inter cell interference co-ordination information; the transceiver being further configured to transmit the collective neighbor cell information to at least one apparatus serving a sub cell.

The apparatus may be configured to transmit the collective neighbor cell information periodically.

The apparatus may be configured to transmit the collective neighbor cell information in response to the received sub cell specific spectrum load characteristic.

The apparatus may be configured to receive the at least one sub cell specific spectrum load characteristic from an apparatus serving a sub cell via user equipment.

According to another aspect of the present invention, there is provided a method comprising: determining at least one sub cell specific spectrum load characteristic by an apparatus serving a sub cell; receiving neighbor cell information from an apparatus serving a cell and transmitting the at least one spectrum characteristic to the apparatus serving a cell.

According to another aspect of the present invention, there is provided a method comprising: receiving at least one sub cell specific spectrum load characteristic from an apparatus serving a sub cell; and generating collective neighbor cell information related to received sub cell specific spectrum load characteristics and inter cell interference co-ordination information; and transmitting the collective neighbor cell information to at least one apparatus serving a sub cell.

A chipset may comprise the apparatus discussed above.

According to another aspect of the present invention, there is provided a computer program comprising program code means adapted to perform the methods discussed above.

According to another aspect of the present invention, there is provided an article of manufacture comprising a computer readable medium and embodying program instructions thereon executable by a computer operably coupled to a memory which, when executed by the computer, perform methods discussed above.

According to another aspect of the present invention, there is provided an apparatus comprising means for determining at least one sub cell specific spectrum load characteristic; means for serving the sub cell and receiving neighbor cell information from an apparatus serving a cell and means for serving the sub cell and transmitting the at least one spectrum and characteristic to an apparatus serving a cell.

According to yet another aspect of the present invention, there is provided an apparatus comprising: means for serving a cell; means for receiving at least one sub cell specific spectrum load characteristic from an apparatus serving a sub cell; means for generating collective neighbor cell information related to received sub cell specific spectrum load characteristics and inter cell interference co-ordination information; and means for transmitting the collective neighbor cell information to at least one apparatus serving a sub cell.

Although the various aspects, embodiments and features of the invention are recited independently, it should be appreciated that all combinations of the various aspects, embodiments and features of the invention are possible and within the scope of the present invention as claimed.

### LIST OF DRAWINGS

Embodiments of the present invention are described below, by way of example only, with reference to the accompanying drawings, in which

FIG. 1 illustrates an example of a radio access network structure to which embodiments of the invention may be applied;

FIGS. 2 to 4 are flowcharts illustrating some embodiments of the invention;

FIG. 5 illustrates a simplified example of an apparatus able to serve a sub cell;

FIG. 6 is a simplified example of an apparatus capable to serve a cell; and

FIG. 7 is a simplified example of an apparatus capable to serve as user equipment.

### DESCRIPTION OF EMBODIMENTS

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

Embodiments are applicable to any base station, user equipment, server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture based on Evolved UMTS terrestrial radio access (E-UTRA, UMTS=Universal Mobile Telecommunications System) without restricting the embodiment to such an architecture, however.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN), worldwide interoperability for microwave access (WiMAX), Bluetooth®, personal communications services (PCS) and systems using ultra-wideband (UWB) technology.

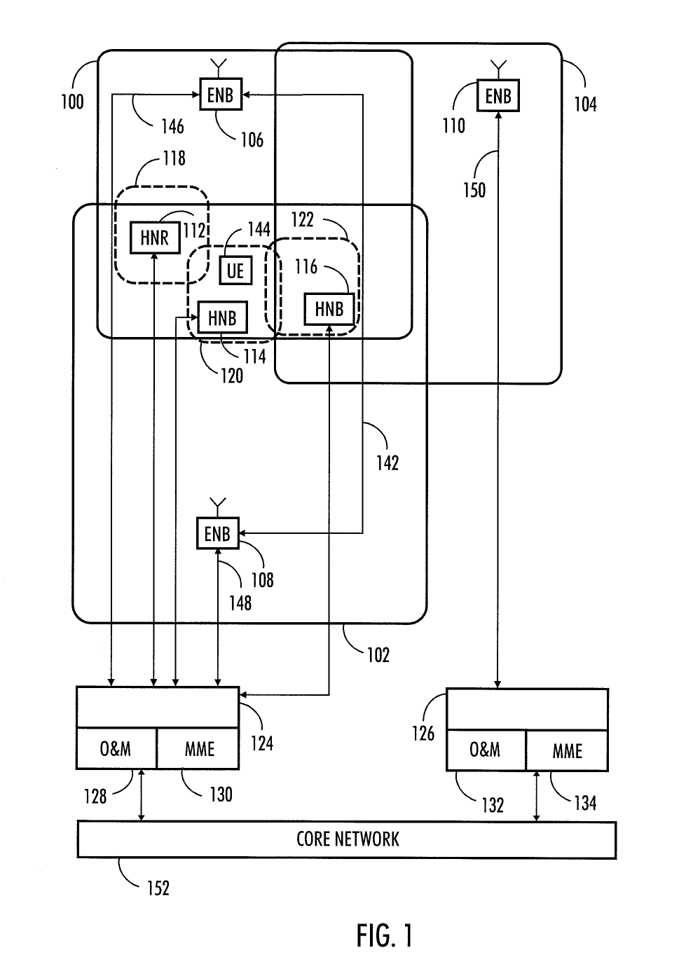

FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

The system architecture of FIG. 1 shows cells 100, 102, 104 of two radio access networks based on LTE standard located in the same geographical area and operated by different operators. Base stations 106 and 108 associated with the cells 100 and 102 are operated by operator A and base station 110 associated with the cell 104 is operated by operator B. In an embodiment, the cells 100, 102, 104 are installed by network operators. Operators may have performed networks planning calculations to optimize spectrum usage and load of the nodes serving the cells. In E-UTRA network the base stations 106, 108, and 110 may be called Enhanced Node B:s (ENB). These base stations may be called Wide Area (WA) base stations.

In addition, FIG. 1 shows three local area (LA) base stations 112, 114, 116 which each serve a sub cell 118, 120, 122, correspondingly. The sub cells are located on the same geographical area as cells 100 and 102. In the example of FIG. 1, the sub cells 118 and 120 are within the coverage areas of cells 100 and 102 and the sub cell 122 is within the coverage areas of cells 100, 102 and 104. The base stations may be installed within buildings to provide additional coverage and capacity in homes and offices. In E-UTRA network the base stations may be called home node Bs (HNB) or local node Bs (LNB). A home node B may be a wireless access point that may be purchased and/or installed by a private user, for example in the user's home. These base stations may utilize so called “plug-and-play” operation with self-organizing network (SON) and flexible spectrum use (FSU) techniques.

FIG. 1 illustrates only a simplified example. In practice, each network may include more cells, more operators may exist in the geographical area, more sub cells formed by home node Bs may be provided, the networks of two or more operators may overlap, the sizes and form of the cells vary from that depicted in FIG. 1, etc.

In FIG. 1, the ENBs 106, 108 of the operator A may be coupled 146, 148 to common servers 124 of the network of the operator A, while the ENB 110 of the operator B may be coupled 150 to common servers 126 of the network of the operator B. The couplings may be realised with wireless or wired connections. The common servers 124, 126 may include operation and maintenance (O&M) servers 128, 130 and mobility management servers 132, 134. Typically, the functionalities of the O&M servers 128, 130 include initial cell-level radio resources allocation, performance monitoring, for example. The functionalities of the mobility management servers 132, 134 may take care of routing the connections of user equipment. The connections 146, 148, 150 between the ENBs and the servers may be implemented by using Internet Protocol (IP) connections. In E-UTRAN specifications the interface is called 51 interface. The ENBs of the same operator may communicate with each other over an X2 interface 142 and with mobility management entity over an 51 interface. These interfaces are described in more detail in E-UTRAN specifications and need thus not be explained herein.

In the example of FIG. 1, the local area base stations 112, 114, 116 may be connected to the common servers 124 of the network of the operator A. The local area base stations may have a connection to the base station 106 or 108 serving the cell in which area the local base station is operating. In this example, we may assume that the local area base stations have a connection with ENB 106. However, local area base stations do not necessarily support X2 interface.

FIG. 1 shows user equipment 144. The user equipment is in sub cell 120 served by the HNB 114. The user equipment is also in the cell served by the ENB 106. The user equipment refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

It should be appreciated that the node Bs are also connectable to a core network (CN) 152 directly or via a radio network controller (not shown in the Figure). Depending on the system, the counterpart on the CN side can be a mobile services switching centre (MSC), a media gateway (MGW) or a serving GPRS (general packet radio service) support node (SGSN), home node B gateway (HNB-GW), mobility management entity and enhanced packet core gateway (MME/EPC-GW), etc. Also a direct communication between different node Bs over the air interface is possible by implementing a relay node concept, wherein a relay node may be considered as a special node B having wireless backhauls or, e.g., X2 and 51 interfaces relayed over the air interface by another node B. The communication system is also able to communicate with other networks, such as a public switched telephone network.

The embodiments are not, however, restricted to the system given above as an example but a person skilled in the art may apply the solution to other communication systems provided with the necessary properties.

Typically, in a geographical area of a radio communication system there is provided a plurality of different kinds of radio cells as well as a plurality of radio cells as also shown in FIG. 1. A cellular radio system may be implemented as a multilayer network including macro-, micro and pico-cells. Each of the cells may be arranged to have a unique identity (such as a cell global Identity (CGI), cell identifier (CID) or physical layer cell identifier (PLCID)) for distinctly identifying the cells.

Recently, for fulfilling the need for improving the deployment and performance of communication systems, concept of “plug-and-play” node Bs has been introduced. Typically, a network which is able to use “plug-and-play” node Bs, includes, in addition to home node Bs, home node B gateway, or HNB-GW. The interface between the home node B (HNB) and the HNB-GW may be an Ilu-h interface. A local node B (LNB) may provide similar kind of functionality as a HNB (but it is more generic).

Term “plug-and-play” is used herein to describe an apparatus which can be coupled to a network with a minimum configuration work, typically such an apparatus is a self-configuring device. For enabling “plug-and-play” devices a self-organizing network (SON) and flexible spectrum use (FSU) concepts have been launched. The SON concept is for instance known in connection to computer networks and neural networks. The FSU enables devices to use spectrum in a flexible manner. In future networks, more frequency bands will be needed for new high-bit-rate wireless services.

A home node B (sometimes being comparable to a femto or pico node) when coupled to broadband services providing an umbrella cell provides radio coverage for user devices. HNBs may provide the capabilities of a standard node B as well as the radio resource management functions of a standard radio network controller (RNC).

A HNB when serving as a “plug-and-play” node B may be a wireless access point purchased, installed and operated by a private user. Thus, the exact location of a HNB under the umbrella cell (or macro cell) when the HBN is wirelessly coupled to a network may not be known or it is of uncoordinated random nature which causes problems in network configuration.

A home node B may be used in a local area network (LAN) which is a computer network covering a relatively small geographical area, such as a home or office. Similar kinds of networks are personal area networks (PANs), campus area networks (CANs), or metropolitan area networks (MANs).

Another network system where HNBs are typically used is a Wide Area Network (WAN) which is a network covering a relatively broad area. A WAN may be defined to be a network whose coverage crosses metropolitan, regional, or national boundaries.

An example of a network system is also a mixed Local Area/Wide Area (LA/WA) scenario in which several cellular networks of the same radio access technology (e.g. E-UTRA) being operated by different operators are deployed in the same geographical area, such as a modern home-and-office building complex, and are using the same radio spectrum resources.

The mixed LA/WA scenarios may for instance refer to hierarchical cell structures, such as to a LTE/LTE or LTE/LTE-A co-existence or hot spots with overlay network. Within LA/WA coverage, HNBs of LNBs of the same or different networks may be placed and set up next to each other in a short distance in a spatially uncoordinated fashion.

When local or home base stations are initialised they may be started as active user equipment or a relay node of a wide area base station for initial cell configuration. In an embodiment, the wide area base station may assign at initial set-up phase a local or home base station a valid user equipment identity such as C-RNTI (Cell Radio Network Temporary Identifier). They may retain the connection to wide area base station for operation and maintenance and radio resource management support during operation time of the local or home base station.

The inter-cell and co-channel interferences affect the operation of individual cells in the neighbourhood of the network. The interference problems may be even more severe in LA/WA networks than in ordinary networks due to the use of “plug-and-play” HNBs and LNBs, the lack of coordination between different networks and/or the lack of cooperation between different operators. Reducing the effects of an initial set-up, reconfiguration and reset or removal of a “plug-and-play” device to the network is a challenging task.

Further, a need to balance the spectrum load among HNBs and/or LNBs and WNBs in LA/WA systems exists for obtaining an efficient spectrum sharing and overall radio resource utilization.

In this application, embodiments will be described in conjunction with cellular communications systems. However, it should be understood that the embodiments may be utilized in several kinds of systems, both wired and wireless.

In an embodiment, local area base stations 112, 114, 116 determine sub cell specific spectrum load status (SLS) information. This status information may comprise inter cell interference co-ordination related signaling information.

In an embodiment, the spectrum load status (SLS) information may comprise various cell specific measurements relating to physical resource block usage on uplink and downlink.

In an embodiment, the spectrum load status (SLS) information may comprise physical resource block usage for guaranteed bit rate of real time traffic on the uplink channels. In case the local area base station communicates using frequency division duplexing (FDD) the physical resource block may be a frequency block. If the communication utilizes time division duplexing (TDD) the physical resource block may comprise time slots. If the communication utilizes code division multiple access (CDMA) the physical resource block may comprise spreading codes. Combinations of above are also possible.

Real time traffic comprises usually delay sensitive data. The traffic may comprise voice communication (speech) and streaming audio or video, for example.

The spectrum load status (SLS) information may comprise physical resource block usage of non real time traffic on the uplink channels. Local area base stations may monitor the load status of not delay sensitive data received from user equipment. The not delay sensitive data traffic may comprise data related to browsing the Internet, for example.

In addition, the spectrum load status (SLS) information may comprise physical resource block usage for guaranteed bit rate of real time traffic on the downlink channels. The local area base station may perform monitoring of the real time traffic on the physical resource block usage from the local area base station to user equipment.

Furthermore, the spectrum load status (SLS) information may comprise physical resource block usage of non real time traffic on the downlink channels. Local area base stations may monitor the load status of not delay sensitive data sent to a given user equipment.

In an embodiment, these measurements are defined as a ratio or percentage of used physical resource blocks for a type of traffic over the available physical resource blocks in the same direction over a given time interval. Any non-scheduled transmissions and retransmissions may also be counted as used.

In an embodiment, the above described monitoring may be performed over more than one time period. Thus, the monitoring may produce short-term status information, medium-term status information or long-term status information, for example. The short-term time period may be tens or hundreds of milliseconds, medium-term time period may be hundreds of milliseconds to seconds, and the long-term time period may be from seconds to minutes. These numerical values are merely examples of possible time periods.

In an embodiment, variations of interference condition specific to certain radio band resource blocks of allocated spectrum or overall system bandwidth are taken into account. The local base station may monitor given physical resource blocks regarding the interference conditions occurring in the blocks.

The load information may be classified depending on whether the spectrum usage is sharable or not between different operators.

In an embodiment, the signalling load caused by the spectrum load status reporting is minimised by indicating specified load levels of the cell with integer numbers, such as 1 to 10.

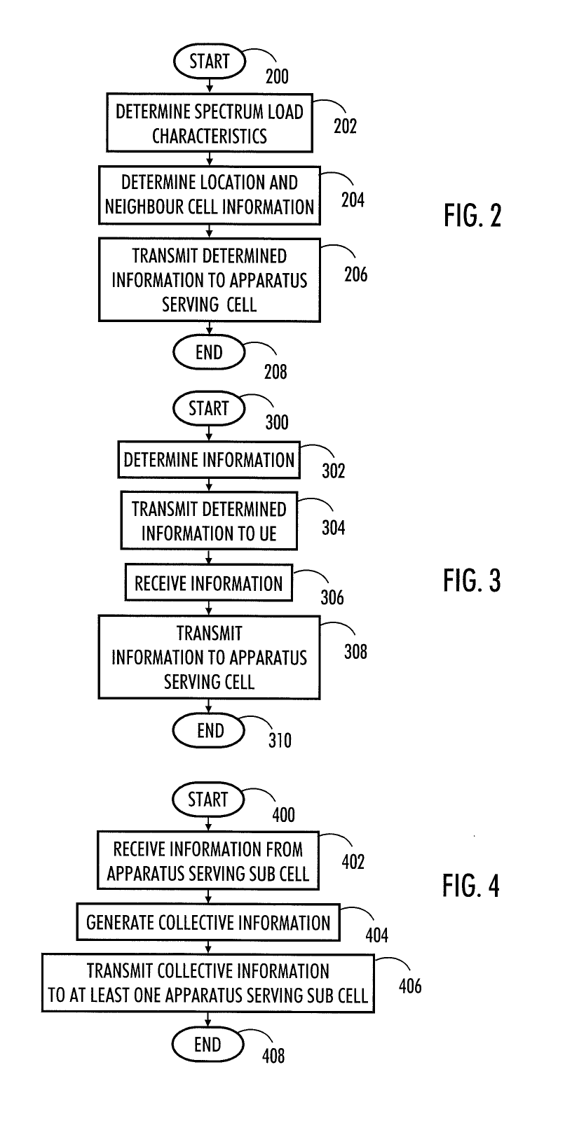

FIGS. 2 to 4 are flowcharts illustrating some embodiments of the invention.

In FIG. 2, the operation starts in step 200.

In step 202, at least one sub cell specific spectrum load characteristic is determined by an apparatus serving a sub cell. In an embodiment, the apparatus is a local area node B or a home node B. The spectrum load characteristic may comprise inter cell interference co-ordination related signaling information.

In addition, the apparatus may determine its location and neighbor cell information in step 204. In an embodiment, the apparatus may receive neighbor cell information from an apparatus serving a cell.

In step 206, the apparatus transmits the determined data to an apparatus serving a cell. In an embodiment, the receiving apparatus is a wide area node B (WNB).

The operation ends in step 208.

FIG. 3 illustrates an example where the local area node B or a home node B transmits the determined information to the apparatus serving a cell via user equipment. In FIG. 3, the operation starts in step 300.

In step 302, at least one sub cell specific spectrum load characteristic is determined by an apparatus serving a sub cell. In an embodiment, the apparatus is a local area node B (LNB) or a home node B (HNB). The spectrum load characteristic may comprise inter cell interference co-ordination related signaling information. In addition, the apparatus may determine its location and neighbor cell information.

In step 304, the LNB or HNB may select suitable user equipment connected to the LNB or HNB and transmit the determined data to user equipment.

In step 306, user equipment receives from the LNB or HNB at least one sub cell specific spectrum load characteristics determined by the LNB or HNB.

In step 308, the user equipment transmits the determined data to an apparatus serving a cell. In an embodiment, the receiving apparatus is a wide area node B (WNB).

The procedure ends in step 310.

In an embodiment, the determined data received by the user equipment comprises the user equipment identifier of the LNB or HNB. The identifier may be C-RNTI, for example. The identifier is different from the identifier of the user equipment. In addition, the determined data transmission may comprise timing advance, other relevant radio link and scheduling information, and actual control information of the LNB or HNB. The additional information may be in form of a coded transport block. This enables the user equipment to act as the LNB to mediate with WNB. Due to rather limited coverage of LNB or HNB, the timing advance information of LNB or HNB toward WNB can be used by the selected user equipment without any problems in transmission. The mediating user equipment is not visible to WNB. Thus, when the WNB receives the transmission comprising the determined data it assumes it comes directly from the HNB or LNB.

In an embodiment, it may be beneficial for LNB or HNB to adopt the above described user equipment assistant method when the number of active user equipment and traffic load in LNB or HNB cell are considerably high.

In an embodiment, the transmission of the determined information is performed periodically. In another embodiment, the transmission is performed on demand. In an embodiment, the demand may be triggered by a change in the determined spectrum load.

In an embodiment, the scheduling of the above periodic reporting and thresholds of cell spectrum load for triggering the above on-demand reporting may be configured and controlled by WNB.

FIG. 4 illustrates an example where an apparatus serving a cell receives determined information. In an embodiment, the apparatus is a wide area node B (WNB) In FIG. 4, the operation starts in step 400.

In step 402, at least one sub cell specific spectrum load characteristic is received from an apparatus serving a sub cell.

In step 404, collective neighbor cell information related to received sub cell specific spectrum load characteristics and inter cell interference co-ordination information is generated.

In step 406, the collective neighbor cell information is transmitted to at least one apparatus serving a sub cell. In an embodiment, the transmission is performed either in response to the received spectrum load information from individual local or home nodes or in periodical update. The period interval may be determined based on the latest knowledge about the surrounding LA/WA environment including neighborhoods of individual local or home nodes.

The procedure ends in step 408.

In an embodiment, the WNB collects and updates its database with the newest information of interest received from local nodes and home nodes located in its cell and also from its neighboring wide area nodes via X2 interface.

In an embodiment, the WNB may utilize dedicated signaling between the WNB and individual local and home nodes for transmitting the collective neighbor cell information.

In some embodiments, where the wide area node is configured to provide more explicit operation and maintenance (O&M) and radio resource management (RRM) support for local and home nodes than just mediating inter cell interference co-ordination related information, the wide area node may send new updates of certain cell-configuration parameters and resource allocation, instead of or in addition to the above collective neighbor cell information.

For example, these updates may relate to cell-specific resource allocation and interference budget for individual local or home nodes, The updates may relate to primary and secondary radio resource blocks or chunks together with corresponding transmit power limits on chunk basis for LNB or HNB data transmissions. The update may specify transmit power for certain cell specific common and control channels, for example.

In some embodiments, common signaling can be used to convey the ICIC related collective neighborhood information from the wide area node to certain groups of relevant neighboring local or home nodes. This case relies on self-optimization of local or home nodes for inter cell interference co-ordination and spectrum load balancing.

In some embodiments, the wide area node may utilize multicast signaling. In such a case, a group user equipment identification (such as C-RNTI) may be allocated to relevant local or home nodes in certain neighborhood.

Some embodiments of the invention provide fast-centralized control and support of umbrella-cell wide area node B (WNB) over the air-interface for local area (LA) deployment and operation under its coverage with plug-and-play local and home nodes. In particular, some embodiments provide an effective control method and mechanism to facilitate fast signalling support of WNB for spectrum load balancing and inter-cell interference coordination and control in mixed local area/wide area scenarios.

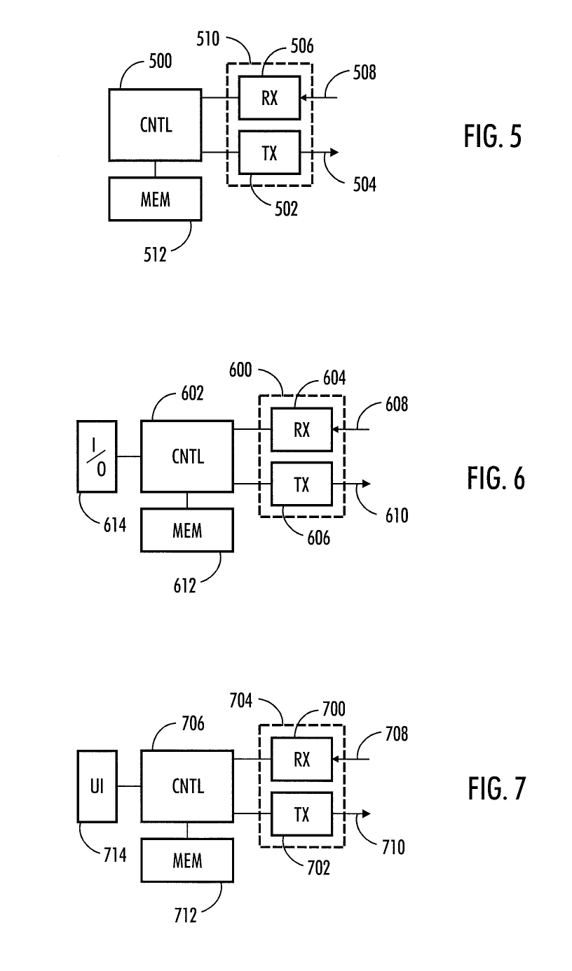

FIG. 5 illustrates a simplified example of an apparatus able to serve a sub cell. In some embodiments, the apparatus may be a home node B or local node B.

It should be understood that the apparatus is depicted herein as an example illustrating some embodiments. It is apparent to a person skilled in the art that the apparatus may also comprise other functions and/or structures. Although the apparatus has been depicted as one entity, different modules and memory may be implemented in one or more physical or logical entities.

The apparatus may be any server, node, host or corresponding component providing required functionality. The apparatus may also be a user device which is a piece of equipment or a device that associates, or is arranged to associate, the user device and its user with a subscription and allows a user to interact with a communications system. The user device presents information to the user and allows the user to input information. In other words, the user device may be any terminal capable of receiving information from and/or transmitting information to the network, connectable to the network wirelessly or via a fixed connection. Examples of the user devices include a personal computer, game console, laptop (notebook), personal digital assistant (PDA), pager, mobile television, mobile station, and line telephone.

A wireless connection may be implemented with a wireless transceiver operating according to any suitable standard/non-standard wireless communication means.

The apparatus may also be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The electronic digital computer may also have an operating system, which may provide system services to a computer program written with the program instructions.

The apparatus of the example includes a controller 500 configured to determine at least one sub cell specific spectrum load characteristic. The spectrum load characteristic may comprise inter cell interference co-ordination related signaling information. In addition, the controller may be configured to determine the location of the apparatus and neighbor cell information.

The apparatus further comprises a transmitter 502 configured to serve the sub cell and transmit the at least one spectrum and characteristic to an apparatus serving a cell. The transmitter is operationally connected to the controller and comprises an interface 504 to an antenna arrangement. The transmitter may be configured to transmit inter cell interference co-ordination related signaling information and the location of the apparatus and neighbor cell information together with the at least one sub cell specific spectrum load characteristic.

The apparatus may further comprise a receiver 506 configured to serve the sub cell. The receiver is operationally connected to the controller 500 and comprises an interface 508 to an antenna arrangement. The receiver and the transmitter may be connected to the same antenna arrangement or they may be connected to different antenna arrangements.

The transmitter and receiver may be realized as a transceiver 510 comprising transmitting and receiving parts.

The apparatus may further comprise a memory 512 for storing software and/or data. The memory may be integrated in the controller.

In an embodiment, the controller 500 may be configured to control the transmitter 502 to transmit sub cell specific spectrum load characteristic to an apparatus serving a cell via user equipment. Thus, user equipment may be used to mediate the spectrum load characteristic to a wide area node.

In an embodiment, the controller 500 may be configured to control the transmitter to transmit to the mediating user equipment the user equipment identifier, timing advance, other relevant radio link and scheduling information of the apparatus. Thus, the user equipment may transmit the data to the wide area node using the identity of the apparatus. The wide area node is unaware of role of the mediating user equipment.

In an embodiment, the controller 500 may be configured to control the receiver 508 to receive data from an apparatus serving a cell via user equipment. The data may comprise one or more of the following: neighbor cell information, cell configuration parameters, and resource allocation information.

The controller 500 may also include circuitry, such as processors and software for implementing other functionalities of the apparatus, such as audio and logic functions. The controller 500 may be realised with one or more separate controlling devices.

The apparatus may also include other parts and/or functionalities than those shown in FIG. 5, such as a connectivity program and user interface.

It should be understood that the apparatus may also solely comprise the controller, in which case the receiver and transmitter mean the capability of the controller to receive and transmit information to units or entities it is coupled to.

FIG. 6 is a simplified example of an apparatus capable to serve a cell. In some embodiments, the apparatus may be a node B controlling a cell.

It should be understood that the apparatus is depicted herein as an example illustrating some embodiments. It is apparent to a person skilled in the art that the apparatus may also comprise other functions and/or structures. Although the apparatus has been depicted as one entity, different modules and memory may be implemented in one or more physical or logical entities.

The apparatus may be any server, node, host or corresponding component providing required functionality.

The apparatus of the example includes a transceiver 600 configured to serve a cell. The transceiver may be configured to receive at least one sub cell specific spectrum load characteristic from an apparatus serving a sub cell.

The apparatus may further comprise a controller 602 configured to generate collective neighbor cell information related to received sub cell specific spectrum load characteristics and inter cell interference co-ordination information. The controller may be configured to generate updates of cell configuration parameters and/or resource allocation. The controller 602 may be realised with one or more separate controlling devices.

The transceiver 600 of the apparatus may be further configured to transmit the collective neighbor cell information and other information to at least one apparatus serving a sub cell.

The transceiver may be realized as a receiver 604 and transmitter 606. The transceiver is operationally connected to the controller 600. The receiver 604 and transmitter 606 may comprise interfaces 608 and 610 to an antenna arrangement.

The apparatus may further comprise a memory 612 for storing software and/or data. The memory may be integrated in the controller.

The controller 602 may also include circuitry, such as processors and software for implementing other functionalities of the apparatus, such as audio and logic functions.

The apparatus may comprise an interface 614 for connecting the apparatus to a common server of a radio system. The common server may provide the apparatus with operation and maintenance and mobility management services, for example. The interface to the common server may be realized as a wired or a wireless connection.

The apparatus may also include other parts and/or functionalities than those shown in FIG. 6, such as a connectivity program and user interface.

FIG. 7 is a simplified example of an apparatus capable to serve as user equipment. The apparatus comprises a receiver 700 configured to receive at least one sub cell specific spectrum load characteristic from an apparatus serving a sub cell and a transmitter 702 configured to transmit the characteristic to an apparatus serving a cell.

The transmitter 702 and receiver 700 may be realized as a transceiver 704 comprising transmitting and receiving parts.

The apparatus may further comprise a controller 706 configured to control the operation of the apparatus. The controller 706 may be realised with one or more separate controlling devices.

The transceiver 704 or the transmitter receiver 700 and the transmitter 702 may be operationally connected to the controller 706. The receiver 700 and transmitter 702 may comprise interfaces 708 and 710 to an antenna arrangement.

The apparatus may further comprise a memory 712 for storing software and/or data. The memory may be integrated in the controller. The memory may be configured to store a given user equipment identifier allocated to the apparatus. In an embodiment, the sub cell specific spectrum load characteristic transmission received from an apparatus serving a sub cell comprises a user equipment identifier different to the identifier of the apparatus. The apparatus may further comprise a user interface 714 with a display, a keyboard, a microphone and a speaker, for example.

The transmitter 702 may be configured to transmit the sub cell specific spectrum load characteristic with the received user equipment identifier which is different to the identifier of the apparatus.

In an embodiment, the controller 706 may be configured to control the receiver 700 to receive from the apparatus serving a sub cell the user equipment identifier, timing advance, other relevant radio link and scheduling information of the apparatus serving a sub cell. Thus, the user equipment may transmit the data to an apparatus serving a cell using the identity of the apparatus serving a sub cell. The apparatus serving a cell is unaware of role of the mediating user equipment.

In an embodiment, the controller 706 may be configured to control the receiver 700 to receive data from an apparatus serving a cell. The data may comprise one or more of the following: neighbor cell information, cell configuration parameters, resource allocation information. The controller 706 may be configured to control the transmitter 702 to mediate the received data to the apparatus serving a sub cell.

In an embodiment, the apparatus of FIG. 7 refers to a portable computing device. Such computing devices include wireless mobile communication devices operating with or without a subscriber identification module (SIM), including, but not limited to, the following types of devices: mobile phone, smartphone, personal digital assistant (PDA), handset. The connection provided by the transceiver 704 may be implemented with a wireless transceiver operating according to the GSM (Global System for Mobile Communications), WCDMA (Wideband Code Division Multiple Access), WLAN (Wireless Local Area Network) or Bluetooth® standard, or any other suitable standard/non-standard wireless communication means.

The apparatuses of FIGS. 5, 6 and 7 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

The apparatuses of FIGS. 5, 6 and 7 may be implemented using at least one chipset or integrated circuit such as ASICs (application-specific integrated circuit).

Embodiments of the invention may be implemented as computer software executable by a processor, or as a combination of software and hardware.

An embodiment provides a computer program embodied on a distribution medium, comprising program instructions which, when loaded into an electronic apparatus, perform the actions of the controller, transmitter, receiver and other units of the apparatuses described earlier.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The steps, signaling messages and related functions described above in FIGS. 2 to 7 are in no absolute chronological order, and some of the steps may be performed simultaneously or in an order differing from the given one. Other functions can also be executed between the steps or within the steps and other signaling messages sent between the illustrated messages. Some of the steps or part of the steps can also be left out or replaced by a corresponding step or part of the step.

It will be obvious to a person skilled in the art that, as technology advances, the inventive concept can be implemented in various ways. The invention and its embodiments are not limited to the examples described above but may vary within the scope of the claims.

1. An apparatus comprising: a controller configured to determine at least one sub cell specific spectrum load characteristic; a receiver configured to serve the sub cell and receive neighbor cell information from an apparatus serving a cell; and a transmitter configured to serve the sub cell and transmit the at least one spectrum and characteristic to the apparatus serving a cell.

2. The apparatus of claim 1, wherein the spectrum load characteristic comprises inter cell interference co-ordination related signaling information.

3. The apparatus of claim 1, wherein the transmitter is configured to transmit the spectrum load characteristic periodically or on demand.

4. The apparatus of claim 1, wherein the apparatus is at least one of: a local area node B; a home node B.

5. The apparatus of claim 1, wherein the apparatus is configured to transmit the at least one sub cell specific spectrum load characteristic to an apparatus serving a cell via user equipment.

6. The apparatus of claim 1, wherein the apparatus is configured to receive at least one of the following from an apparatus serving a cell via user equipment: neighbor cell information, cell configuration parameters, resource allocation information.

7. The apparatus of claim 5, wherein the apparatus is configured to select and provide the mediating user equipment with the user equipment identifier, timing advance, other relevant radio link and scheduling information of the apparatus.

8. The apparatus of claim 1, wherein the apparatus comprises a controller configured to determine the location of the apparatus and neighbor cell information of the apparatus and a transmitter configured to transmit the determined information together with the at least one sub cell specific spectrum load characteristic.

9. An apparatus comprising: a transceiver configured to serve a cell and configured to receive at least one sub cell specific spectrum load characteristic from an apparatus serving a sub cell; and a controller configured to generate collective neighbor cell information related to received sub cell specific spectrum load characteristics and inter cell interference co-ordination information; the transceiver being further configured to transmit the collective neighbor cell information to at least one apparatus serving a sub cell.

10. The apparatus of claim 9, wherein the apparatus is configured to transmit the collective neighbor cell information periodically.

11. The apparatus of claim 9, wherein the apparatus is configured to transmit the collective neighbor cell information in response to the received sub cell specific spectrum load characteristic.

12. The apparatus of claim 9, wherein the transceiver is further configured to utilize dedicated signaling between the apparatus and the at least one apparatus serving a sub cell when transmitting collective neighbor cell information.

13. The apparatus of claim 9, wherein the transceiver is further configured to transmit updates of cell configuration parameters and/or resource allocation to at least one apparatus serving a sub cell.

14. The apparatus of claim 9, wherein the transceiver is further configured to utilize common signaling between apparatus and a given set of apparatuses serving sub cells when transmitting inter cell interference co-ordination related collective neighbor cell information.

15. The apparatus of claim 9, wherein the controller is configured to determine updates of cell-configuration parameters and resource allocation and the transceiver is configured to transmit the determined information to at least one apparatus serving a sub cell.

16. A method comprising: determining at least one sub cell specific spectrum load characteristic by an apparatus serving a sub cell; receiving neighbor cell information from an apparatus serving a cell and transmitting the at least one spectrum characteristic to the apparatus serving a cell.

17. The method of claim 16, wherein the spectrum load characteristic comprises inter cell interference co-ordination related signaling information.

18. The method of claim 16, further comprising: transmitting the at least one spectrum load characteristic periodically or on demand.

19. The method of claim 16, wherein the transmitting apparatus is at least one of: a local area node B; a home node B.

20. The method of claim 16, further comprising: utilising self-organizing network and flexible spectrum techniques in the transmitting apparatus.

21. The method of claim 16, further comprising: transmitting the at least one sub cell specific spectrum load characteristic to an apparatus serving a cell via user equipment.

22. The method of claim 21, further comprising: receiving at least one of the following from an apparatus serving a cell via user equipment: neighbor cell information, cell configuration parameters, resource allocation information.

23. The method of claim 21, further comprising: selecting and providing the mediating user equipment with the user equipment identifier, timing advance, other relevant radio link and scheduling information of the apparatus.

24. A method comprising:
receiving at least one sub cell specific spectrum load characteristic from an apparatus serving a sub cell; and
generating collective neighbor cell information related to received sub cell specific spectrum load characteristics and inter cell interference co-ordination information; and
transmitting the collective neighbor cell information to at least one apparatus serving a sub cell.

25. The method of claim 24, further comprising: transmitting the collective neighbor cell information periodically.

26. The method of claim 24, further comprising: transmitting the collective neighbor cell information in response to the received sub cell specific spectrum load characteristic.

27. The method of claim 24, further comprising: utilizing dedicated signaling between the transmitting apparatus and the at least one apparatus serving a sub cell when transmitting collective neighbor cell information.

28. The method of claim 24, further comprising: transmitting updates of cell configuration parameters and/or resource allocation to at least one apparatus serving a sub cell.

29. The method of claim 24, further comprising: utilizing common signaling between apparatus and a given set of apparatuses serving sub cells when transmitting inter cell interference co-ordination related collective neighbor cell information.

30. The method of claim 24, further comprising: determining updates of cell-configuration parameters and resource allocation and transmitting the determined information to at least one apparatus serving a sub cell.

31. A chipset comprising the apparatus of claim 1.

32. A computer program comprising program code means adapted to perform any of steps of claim 16 when the program is run on a computer.

33. An article of manufacture comprising a computer readable medium and embodying program instructions thereon executable by a computer operably coupled to a memory which, when executed by the computer, perform any of steps of claims 16.

34. An apparatus comprising:
means for determining at least one sub cell specific spectrum load characteristic; means for serving the sub cell and receiving neighbor cell information from an apparatus serving a cell and
means for serving the sub cell and transmitting the at least one spectrum and characteristic to an apparatus serving a cell.

35. An apparatus comprising:
means for serving a cell;
means for receiving at least one sub cell specific spectrum load characteristic from an apparatus serving a sub cell;
means for generating collective neighbor cell information related to received sub cell specific spectrum load characteristics and inter cell interference co-ordination information; and
means for transmitting the collective neighbor cell information to at least one apparatus serving a sub cell.
